(19) United States
(12) Patent Application Publication
(10) Pub. No.: US 2022/0129803 A1
(43) Pub. Date: Apr. 28, 2022

(54) DETECTING SUPPLY CHAIN ISSUES IN CONNECTION WITH INVENTORY MANAGEMENT USING MACHINE LEARNING TECHNIQUES

(71) Applicant: Dell Products L.P., Round Rock, TX (US)

(72) Inventors: Sathish K. Bikumala, Round Rock, TX (US); Deepak Nagarajegowda, Cary, NC (US)

(21) Appl. No.: 17/078,533

(22) Filed: Oct. 23, 2020

(51) Int. Cl. G06Q 10/06; G06Q 10/08; G06Q 30/00; G06Q 30/02; G06Q 10/10; G06N 5/04; G06F 16/901

(52) U.S. Cl. CPC G06Q 10/0635; G06Q 10/087; G06Q 30/0185; G06Q 10/067; G06F 16/9024; G06Q 10/0838; G06Q 10/10; G06N 5/04; G06Q 30/0201

(57) ABSTRACT

Methods, apparatus, and processor-readable storage media for detecting supply chain issues in connection with inventory management using machine learning techniques are provided herein. An example computer-implemented method includes obtaining data pertaining to inventory items in connection with a supply chain; training machine learning techniques using the obtained data, wherein training the machine learning techniques comprises determining upper bounds and lower bounds for parameters related to the supply chain; detecting anomalies in audit data pertaining to at least one inventory item within the supply chain by processing the audit data using the machine learning techniques; generating a graph representing the supply chain based on the obtained data and the audit data; identifying at least one issue within the at least one supply chain by processing the graph in connection with the detected anomalies using graph algorithms; and performing an automated action based on the identified issue(s).

### FIELD

The field relates generally to information processing systems, and more particularly to security using such systems.

### BACKGROUND

Supply chain issues include a variety of problem areas such as, for example, inventory fraud, which involves the theft of physical inventory items and/or the misstatement of inventory records. Inventory, for many enterprises and other organizations, typically includes raw materials, unfinished goods and/or finished goods that are generally stored (e.g., in one or more warehouses) as part of larger transaction sequences.

As noted above, inventory fraud can include theft of physical inventory items and/or misstatement of inventory records, both of which commonly result in non-trivial loss of resources and money for the given enterprise. Conventional security approaches typically rely on human actors to perform physical counting of inventory items and updating of such counts into a separate system, processes which are error-prone and labor-intensive.

### SUMMARY

Illustrative embodiments of the disclosure provide techniques for detecting supply chain issues in connection with inventory management using machine learning techniques. An exemplary computer-implemented method includes obtaining data pertaining to one or more inventory items in connection with at least one supply chain, and training one or more machine learning techniques using at least a portion of the obtained data, wherein training the one or more machine learning techniques comprises determining one or more upper bounds and one or more lower bounds for one or more parameters related to the at least one supply chain. The method also includes detecting one or more anomalies in audit data pertaining to at least one inventory item within the at least one supply chain by processing at least a portion of the audit data using the one or more machine learning techniques, and generating at least one graph representing one or more portions of the at least one supply chain based at least in part on one or more portions of the obtained data and one or more portions of the audit data. Further, the method additionally includes identifying at least one issue within at least one portion of the at least one supply chain by processing the at least one graph in connection with the one or more detected anomalies using one or more graph algorithms, and performing at least one automated action based at least in part on the at least one identified issue.

Illustrative embodiments can provide significant advantages relative to conventional security approaches. For example, problems associated with non-trivial loss of resources and money for a given enterprise resulting from error-prone and labor-intensive fraud detection techniques are overcome in one or more embodiments through automatically identifying supply chain issues by processing a supply chain graph in connection with detected anomalies using machine learning techniques and graph algorithms.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for detecting supply chain issues in connection with inventory management using machine learning techniques in an illustrative embodiment.

FIG. 2 shows an example workflow for detecting supply chain issues in connection with inventory management using machine learning techniques in an illustrative embodiment.

FIG. 3 shows an example workflow for detecting supply chain issues in connection with inventory management using machine learning techniques in an illustrative embodiment.

FIG. 4 is a flow diagram of a process for detecting supply chain issues in connection with inventory management using machine learning techniques in an illustrative embodiment.

FIGS. 5 and 6 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

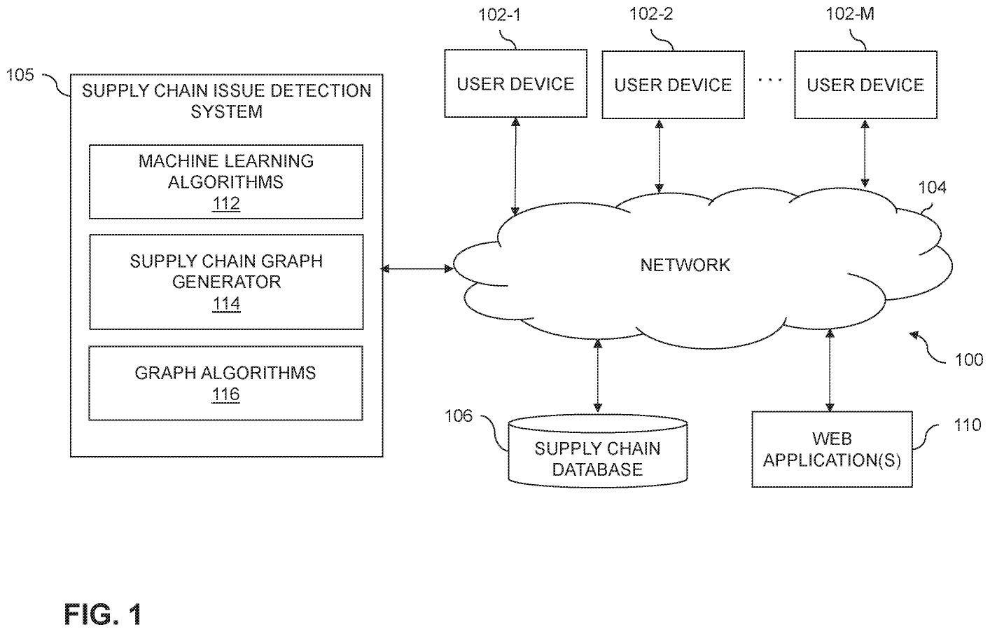

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is supply chain issue detection system 105 and one or more web applications 110 (e.g., one or more security applications, etc.).

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, supply chain issue detection system 105 can have an associated database 106 configured to store data pertaining to supply chain data, which comprise, for example, inventory item data, transaction data, etc.

The database 106 in the present embodiment is implemented using one or more storage systems associated with supply chain issue detection system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with supply chain issue detection system 105 can be one or more input-output devices, which illustratively comprise keyboards, displays or other types of input-output devices in any combination. Such input-output devices can be used, for example, to support one or more user interfaces to supply chain issue detection system 105, as well as to support communication between supply chain issue detection system 105 and other related systems and devices not explicitly shown.

Additionally, supply chain issue detection system 105 in the FIG. 1 embodiment is assumed to be implemented using at least one processing device. Each such processing device generally comprises at least one processor and an associated memory, and implements one or more functional modules for controlling certain features of supply chain issue detection system 105.

More particularly, supply chain issue detection system 105 in this embodiment can comprise a processor coupled to a memory and a network interface.

The processor illustratively comprises a microprocessor, a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows supply chain issue detection system 105 to communicate over the network 104 with the user devices 102, and illustratively comprises one or more conventional transceivers.

The supply chain issue detection system 105 further comprises machine learning algorithms 112, supply chain graph generator 114, and graph algorithms 116.

It is to be appreciated that this particular arrangement of modules 112, 114 and 116 illustrated in supply chain issue detection system 105 of the FIG. 1 embodiment is presented by way of example only, and alternative arrangements can be used in other embodiments. For example, the functionality associated with modules 112, 114 and 116 in other embodiments can be combined into a single module, or separated across a larger number of modules. As another example, multiple distinct processors can be used to implement different ones of modules 112, 114 and 116 or portions thereof.

At least portions of modules 112, 114 and 116 may be implemented at least in part in the form of software that is stored in memory and executed by a processor.

It is to be understood that the particular set of elements shown in FIG. 1 for detecting supply chain issues in connection with inventory management using machine learning techniques involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, two or more of supply chain issue detection system 105, supply chain database 106, and web application(s) 110 can be on and/or part of the same processing platform.

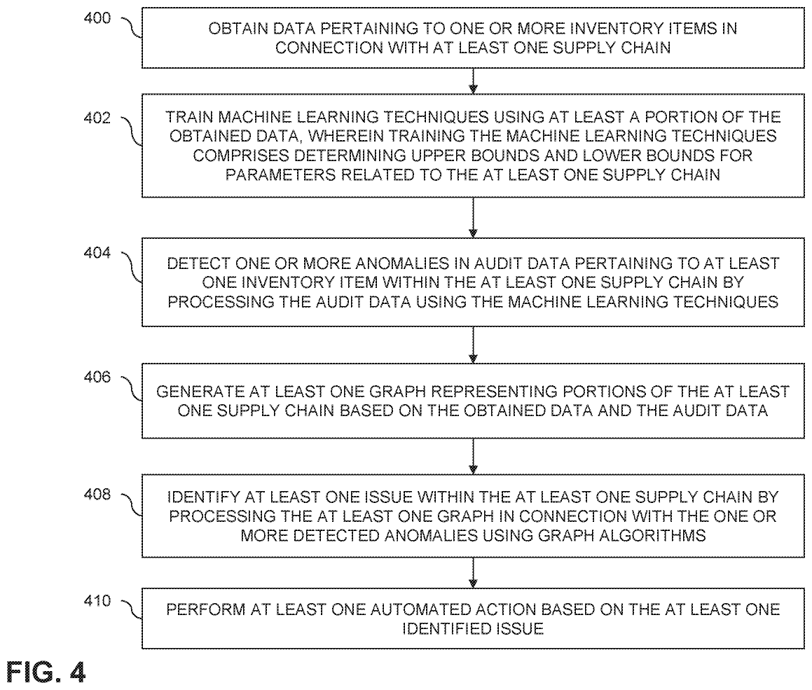

An exemplary process utilizing modules 112, 114 and 116 of an example supply chain issue detection system 105 in computer network 100 will be described in more detail with reference to the flow diagram of FIG. 4.

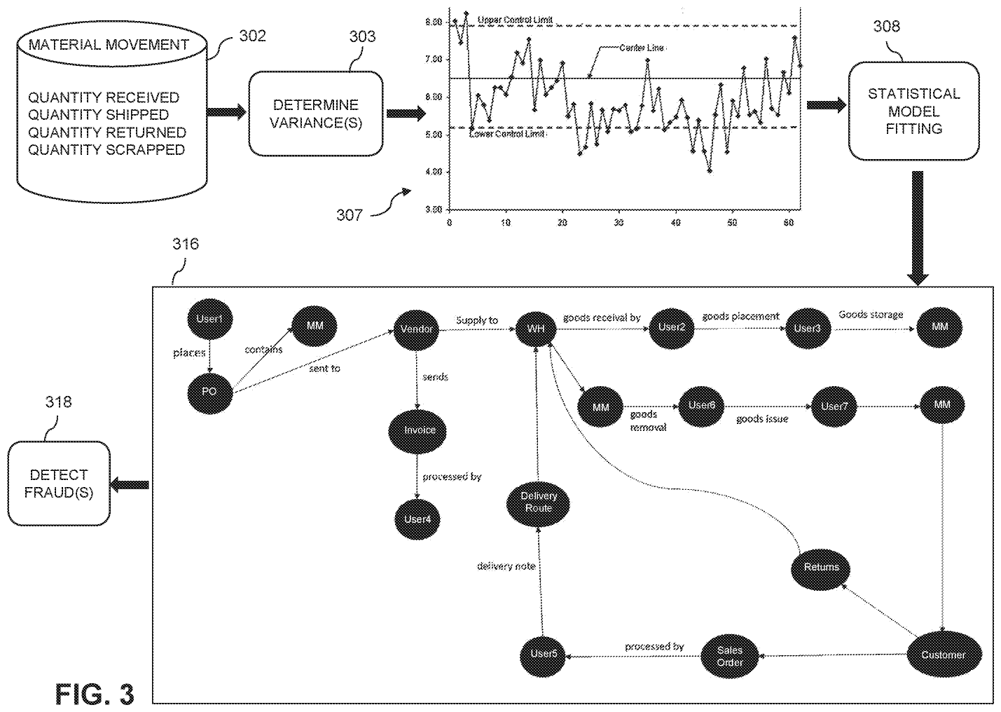

Accordingly, at least one embodiment includes detecting supply chain issues in connection with inventory management using machine learning techniques. Such an embodiment includes carrying out anomaly detection individually on one or more supply chain process areas that pertain to inventory. By way of example, such anomaly detection can be carried out in connection with inventory data related to goods receipts, goods issues, returned goods, scrapped goods, quotes and/or purchase orders, invoices, etc. As used herein, a “goods issue” refers to a potential problem with one or more goods from a warehouse, while “scrapped goods” refer to goods deemed defective and/or obsolete. Additionally, one or more embodiments include, using historical inventory data pertaining to multiple variables (e.g., at least a portion of the variables noted above), generating one or more control charts (such as depicted, for example, in FIG. 3 as graph 307) that display one or more variances with upper and lower bounds.

Such an embodiment further includes training at least one machine learning model for determining if a given variable is outside of the historical data-based upper and lower bounds. Also, such an embodiment includes combining any such determined anomalies and detecting one or more links between the anomalies using graph network analysis. Such links, in one or more embodiments of the invention, can pertain to information such as, for example, discrepancies among related invoices, purchase orders and/or payment records, inventory balances that increase more quickly than sales balances, shipping costs that are decreasing as a percentage of inventory, non-trivial increases in the temporal holding period of inventory items, vendor lists that include companies that do not have websites and/or identifiable business listings, signs of database and/or system manipulation, non-trivial adjustments after physical inventory counts, etc.

Accordingly, as also detailed herein, one or more embodiments include using machine learning techniques and analytics to identify trends, patterns, anomalies, and exceptions within inventory-related data. Such inventory-related data can include, for example, amount of time in inventory (e.g., a value represented by the average inventory divided by an annual cost of sales multiplied by 365 days), gross margin (e.g., sales minus cost of sales) as a percentage of sales, inventory as a percentage of total assets, returns as a percentage of sales, shipping costs as a percentage of sales, etc.

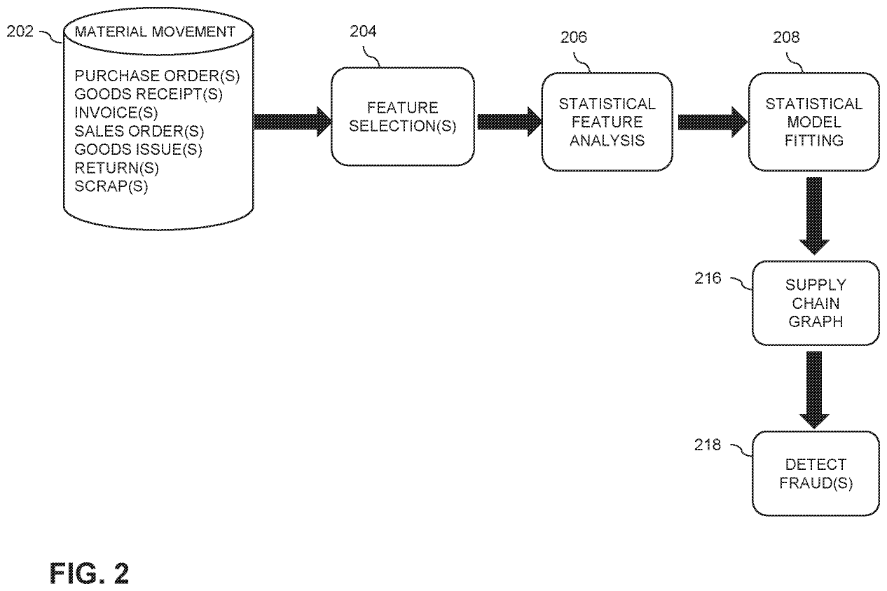

FIG. 2 shows an example workflow for detecting supply chain issues in connection with inventory management using machine learning techniques in an illustrative embodiment. As further detailed herein, for a given material movement (MM), also referred to herein as an inventory item quantity, one or more embodiments can include calculating MM quantity in a warehouse=(the amount of MM received)−(the amount of MM shipped)+(the amount of MM returned)−(the amount of MM scrapped).

By way of illustration, FIG. 2 depicts MM database 202, which includes data pertaining to one or more purchase orders, one or more goods receipts, one or more invoices, one or more sales orders, one or more goods issues, one or more returns, one or more scraps, etc. As also depicted in FIG. 2, step 204 includes feature selection. By way of example, in connection with step 204, at least one embodiment includes, for every MM (such as, for example, the MM associated with database 202), extracting at least a portion of lifetime historical data in various supply chain areas (such as those noted above, for instance) from one or more supply chain systems. Referring again to FIG. 2, step 206 includes statistical feature analysis (based at least in part on the features selected in step 204), and step 208 includes statistical model fitting, which can include fitting at least a portion of the data derived from the statistical feature analysis in step 206 to a supply chain graph 216 which illustrates a flow of data between multiple items, actors, and/or entities within a given supply chain. As further detailed herein, based at least in part on processing the supply chain graph 216 (fit with the above-noted data), one or more embodiments include detecting at least one supply chain fraud or fraudulent activity in step 218.

FIG. 3 shows an example workflow for detecting supply chain issues in connection with inventory management using machine learning techniques in an illustrative embodiment. By way of illustration, FIG. 3 depicts MM database 302, which, similar to MM database 202 in FIG. 2, includes goods-related data pertaining to quantity received, quantity shipped, quantity returned, quantity scrapped, etc. As also depicted in FIG. 3, step 303 includes determining one or more variances from historical norms within the data in MM database 302. Based at least in part on the determined variance(s), at least one embodiment includes generating a variance graph (an example of which is depicted as graph 307), which illustrates an upper control line (or bound) for a given feature or variable, a center line for the given feature or variable, a lower control line (or bound) for the given feature of variable, and an illustration of real values for the given feature or variable derived from the MM database 303. Such a graph (such as, e.g., graph 307) determines instances of feature/variable values that fall outside of the control lines (or bounds), and such determinations can be used (in conjunction with other data derived from MM database 303) to perform statistical model fitting in step 308.

Based at least in part on the statistical model fitting in step 308, which can include fitting at least a portion of the data derived from the variance determination(s) (e.g., via graph 307) and derived from processing data within MM database 302 to a supply chain graph (an example of which is depicted as graph 316) which illustrates a flow of data between multiple items, actors, and/or entities (e.g., users, purchase orders (POs), MMs, vendors, invoices, warehouses (WHs), delivery routes, returns, sales orders (SOs), customers, etc.) within the supply chain related to MM database 302. Additionally, based at least in part on processing the supply chain graph (such as, e.g., graph 316), one or more embodiments include detecting at least one supply chain fraud or fraudulent activity in step 318. By way of example, as the supply chain graph (e.g., graph 316) has been fitted with data pertaining to multiple variables (e.g., timing, amounts, costs, etc.) illustrating a sequence of events within the given supply chain, one or more detected anomalies (determined, for example, in connection with the variance determinations and variance graph 307) can be attributed to one or more actors or entities within the supply chain by processing at least portions of such data within the context of the supply chain graph (e.g., graph 316).

In one or more embodiments, one or more features related to a given MM are extracted in chronological order. Also, in such an embodiment, data extraction includes utilizing entities that can provide data context such as, for example, MM category, quantity values, user identifying information, timestamp information, location information, supplier information, vendor information, related third-party information, information pertaining to mode of payment, payment terms, pricing information, etc.

At least one embodiment also includes monitoring one or more inventory metrics. Such metrics can include, by way merely of example, various computed inventory ratios such as amount of time in inventory (e.g., average inventory divided by annual cost of sales multiplied by 365 days), gross margin (e.g., sales minus cost of sales) as a percentage of sales, inventory as a percentage of total assets, returns as a percentage of sales, shipping costs as a percentage of sales, etc.

Additionally, one or more embodiments includes performing audit variance analysis. In such an embodiment, input data in the form of audit data (which, for example, can be obtained periodically from one or more external systems) are processed using one or more techniques (e.g., the Poisson distribution) to model at least one cumulative variance for use in connection with one or more machine learning techniques. Also, at least one embodiment can further include incorporating supply chain data context for audit variance analysis.

In such an embodiment, relevant supply chain documents and/or transaction information are extracted for each audit window. By way merely of example, for a given MM, assume that all POs placed will be extracted. In this example illustration, assume that such POs include PO#100 and PO#101. Assuming the MM information has been obtained during the same window as at least one audit under analysis, goods received quantity data and goods placed data will be added and/or incorporated as well. Similarly, in this example illustration, for the reverse flow of the MM (i.e., out of the warehouse), relevant SO numbers will be retrieved along with data pertaining to quantity supplied against each of the sales orders. Additionally, any returned goods data and/or scrapped goods data related to the POs and/or SOs will be incorporated and/or analyzed as well. Accordingly, for each audit time window, one or more embodiments include processing data pertaining to all supply chain transactions for each MM identifier using at least one data chain and link analysis in the form of graph data.

As detailed herein, at least one embodiment includes generating supply chain context using one or more graph algorithms. Continuing with the above-noted example, data pertaining to all supply chain transactions for each MM identifier are processed and converted to at least one graph. Such an embodiment can include, for example, fitting data derived from statistical feature analysis of MM data to an existing graph which illustrates a flow of data and/or goods between multiple items, actors, and/or entities within a given supply chain, or generating a new supply chain graph illustrating known actors or entities within a given supply chain and a flow of data and/or goods between them based on statistical feature analysis of MM data. In one or more embodiments, such a graph visualizes at least a portion of entities within a supply chain and pertinent information corresponding thereto, such as, for example, one or more users and/or customers, one or more vendors, date and time of each transaction, location of each entity, etc.

Additionally, one or more embodiments include processing at least portions of such a generated supply chain graph using one or more machine learning algorithms. Such algorithms can include a PageRank algorithm, which measures the importance of each vertex in a graph, assuming an edge from u to v represents an endorsement of v's importance by u. Additionally or alternatively, such algorithms can include at least one connected-component labeling algorithm, which labels each connected component of the graph with the identifier (ID) of its lowest-numbered vertex. By way of illustration, in a given network, using such an algorithm, connected components can approximate clusters.

Further, such machine learning algorithms can include at least one triangle counting algorithm. In such an embodiment, a vertex is considered part of a triangle when the vertex has two adjacent vertices with an edge between them. Additionally, such machine learning algorithms can include at least one GraphX algorithm, which implements a triangle counting algorithm in the triangle count objects that determines the number of triangles passing through each vertex, providing a measure of clustering. Further, such machine learning algorithms can include at least one Louvain modularity algorithm, which can be used for community detection in a graph network and/or for evaluating the structure of complex networks, such as, for example, uncovering levels of hierarchies. Also, in accordance with one or more embodiments, such machine learning algorithms can include at least one degree centrality algorithm, which counts the number of incoming and outgoing relationships from a node and can be used to detect popular nodes in a graph.

Accordingly, at least one embodiment includes using one or more such machine learning algorithm to detect one or more unusual and/or suspicious patterns in a graph network with respect to one or more users and/or transactions. In such an embodiment, one or more events corresponding to each such detected pattern can be evaluated further using at least one Bayesian inference to calculate the probability of occurrence of such an event. If, in such an embodiment, the calculated probability exceeds a certain threshold, the given event can be tagged and/or identified as fraud and can be subjected to further investigation and/or trigger one or more automated actions (e.g., an email notification to one or more security systems and/or entities).

As detailed herein, at least one embodiment includes using one or more graph algorithms to detect at least one network of fraud using supply chain processes. Such an embodiment does not need supervised data, and can instead include using one or more unsupervised techniques coupled with anomaly detection and one or more network graphs to detect a fraud within a supply chain and/or inventory-related system or network.

FIG. 4 is a flow diagram of a process for detecting supply chain issues in connection with inventory management using machine learning techniques in an illustrative embodiment. It is to be understood that this particular process is only an example, and additional or alternative processes can be carried out in other embodiments.

In this embodiment, the process includes steps 400 through 410. These steps are assumed to be performed by the supply chain issue detection system 105 utilizing its modules 112, 114 and 116.

Step 400 includes obtaining data pertaining to one or more inventory items in connection with at least one supply chain. In one or more embodiments, the data pertaining to the one or more inventory items include information pertaining to at least one of inventory item category, inventory item quantity, inventory item user, one or more inventory item timestamps, inventory item location, inventory item supplier, inventory item vendor, mode of payment, one or more payment terms, and inventory item pricing. Additionally or alternatively, in one or more embodiments, the data pertaining to the one or more inventory items include one or more inventory metrics including at least one of time spent in inventory, gross margin as a percentage of sales, inventory as a percentage of total assets, returns as a percentage of sales, and shipping costs as a percentage of sales.

Step 402 includes training one or more machine learning techniques using at least a portion of the obtained data, wherein training the one or more machine learning techniques comprises determining one or more upper bounds and one or more lower bounds for one or more parameters related to the at least one supply chain. In at least one embodiment, training the one or more machine learning techniques includes using a Poisson distribution to model a cumulative variance for each of the one or more parameters related to the at least one supply chain.

Step 404 includes detecting one or more anomalies in audit data pertaining to at least one inventory item within the at least one supply chain by processing at least a portion of the audit data using the one or more machine learning techniques. In one or more embodiments, the audit data include, for a given temporal period, transaction data associated with the at least one supply chain.

Step 406 includes generating at least one graph representing one or more portions of the at least one supply chain based at least in part on one or more portions of the obtained data and one or more portions of the audit data. In one or more embodiments, generating the at least one graph includes generating a visualization of at least a portion of entities within a supply chain and information pertaining to one or more links between said entities.

Step 408 includes identifying at least one issue within at least one portion of the at least one supply chain by processing the at least one graph in connection with the one or more detected anomalies using one or more graph algorithms. In at least one embodiment, the one or more graph algorithms can include one or more (e.g., a combination of two or more) of at least one PageRank algorithm, at least one connected-component labeling algorithm, at least one triangle counting algorithm, at least one GraphX algorithm, at least one Louvain modularity algorithm, and at least one degree centrality algorithm.

Step 410 includes performing at least one automated action based at least in part on the at least one identified issue. In at least one embodiment, performing the at least one automated action includes calculating at least one probability of occurrence for the at least one identified issue using one or more Bayesian inference techniques. In such an embodiment, performing the at least one automated action further includes labeling the at least one identified issue as a security risk upon a determination that the at least one calculated probability of occurrence exceeds a given threshold. Additionally or alternatively, in at least one embodiment, performing the at least one automated action includes outputting information pertaining to the at least one identified issue to one or more security systems associated with the at least one supply chain.

Accordingly, the particular processing operations and other functionality described in conjunction with the flow diagram of FIG. 4 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to automatically identify supply chain issues by processing a supply chain graph in connection with detected anomalies using machine learning techniques and graph algorithms. These and other embodiments can effectively overcome problems associated with non-trivial loss of resources and money for a given enterprise due to error-prone and labor-intensive fraud detection techniques.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

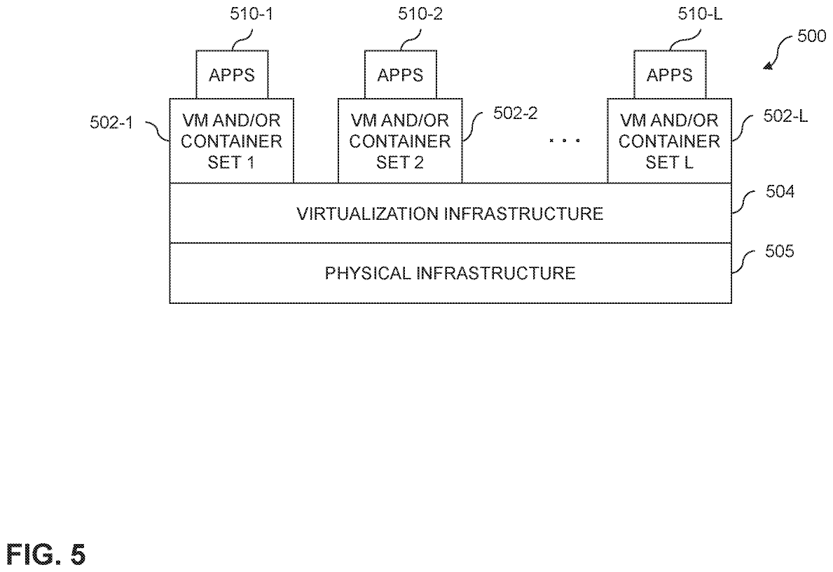

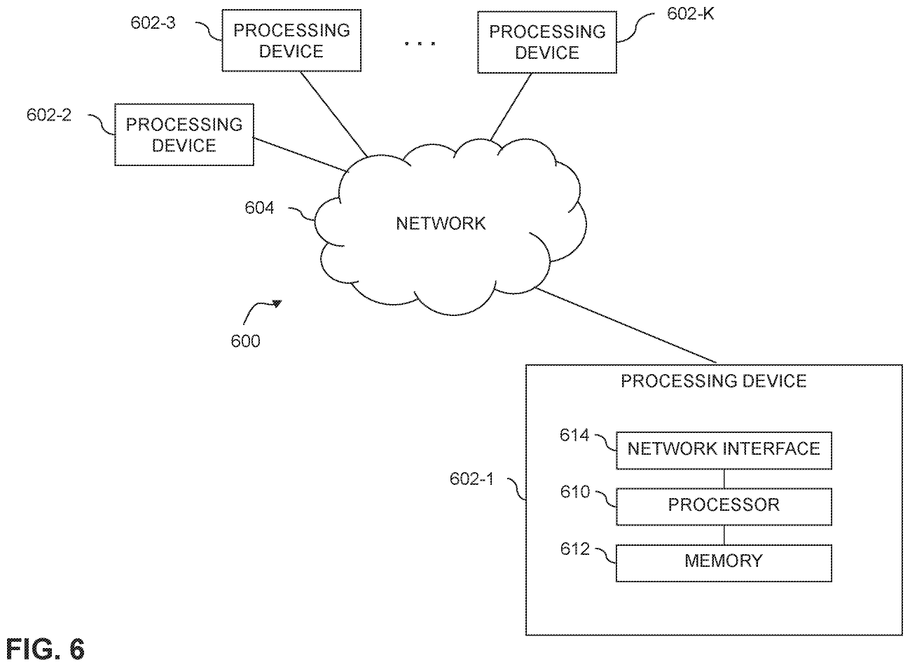

Illustrative embodiments of processing platforms will now be described in greater detail with reference to FIGS. 5 and 6. Although described in the context of system 100, these platforms may also be used to implement at least portions of other information processing systems in other embodiments.

FIG. 5 shows an example processing platform comprising cloud infrastructure 500. The cloud infrastructure 500 comprises a combination of physical and virtual processing resources that are utilized to implement at least a portion of the information processing system 100. The cloud infrastructure 500 comprises multiple virtual machines (VMs) and/or container sets 502-1, 502-2, . . . 502-L implemented using virtualization infrastructure 504. The virtualization infrastructure 504 runs on physical infrastructure 505, and illustratively comprises one or more hypervisors and/or operating system level virtualization infrastructure. The operating system level virtualization infrastructure illustratively comprises kernel control groups of a Linux operating system or other type of operating system.

The cloud infrastructure 500 further comprises sets of applications 510-1, 510-2, . . . 510-L running on respective ones of the VMs/container sets 502-1, 502-2, . . . 502-L under the control of the virtualization infrastructure 504. The VMs/container sets 502 comprise respective VMs, respective sets of one or more containers, or respective sets of one or more containers running in VMs. In some implementations of the FIG. 5 embodiment, the VMs/container sets 502 comprise respective VMs implemented using virtualization infrastructure 504 that comprises at least one hypervisor.

A hypervisor platform may be used to implement a hypervisor within the virtualization infrastructure 504, wherein the hypervisor platform has an associated virtual infrastructure management system. The underlying physical machines comprise one or more distributed processing platforms that include one or more storage systems.

In other implementations of the FIG. 5 embodiment, the VMs/container sets 502 comprise respective containers implemented using virtualization infrastructure 504 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 500 shown in FIG. 5 may represent at least a portion of one processing platform. Another example of such a processing platform is processing platform 600 shown in FIG. 6.

The processing platform 600 in this embodiment comprises a portion of system 100 and includes a plurality of processing devices, denoted 602-1, 602-2, 602-3, . . . 602-K, which communicate with one another over a network 604.

The network 604 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 602-1 in the processing platform 600 comprises a processor 610 coupled to a memory 612.

The processor 610 comprises a microprocessor, a microcontroller, an application-specific integrated circuit (ASIC), a field-programmable gate array (FPGA) or other type of processing circuitry, as well as portions or combinations of such circuitry elements.

The memory 612 comprises random access memory (RAM), read-only memory (ROM) or other types of memory, in any combination. The memory 612 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 602-1 is network interface circuitry 614, which is used to interface the processing device with the network 604 and other system components, and may comprise conventional transceivers.

The other processing devices 602 of the processing platform 600 are assumed to be configured in a manner similar to that shown for processing device 602-1 in the figure.

Again, the particular processing platform 600 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of a distributed processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
obtaining data pertaining to one or more inventory items in connection with at least one supply chain;
training one or more machine learning techniques using at least a portion of the obtained data, wherein training the one or more machine learning techniques comprises determining one or more upper bounds and one or more lower bounds for one or more parameters related to the at least one supply chain;
detecting one or more anomalies in audit data pertaining to at least one inventory item within the at least one supply chain by processing at least a portion of the audit data using the one or more machine learning techniques;
generating at least one graph representing one or more portions of the at least one supply chain based at least in part on one or more portions of the obtained data and one or more portions of the audit data;
identifying at least one issue within at least one portion of the at least one supply chain by processing the at least one graph in connection with the one or more detected anomalies using one or more graph algorithms; and
performing at least one automated action based at least in part on the at least one identified issue;
wherein the method is performed by at least one processing device comprising a processor coupled to a memory.

2. The computer-implemented method of claim 1, wherein performing the at least one automated action comprises calculating at least one probability of occurrence for the at least one identified issue using one or more Bayesian inference techniques.

3. The computer-implemented method of claim 2, wherein performing the at least one automated action comprises labeling the at least one identified issue as a security risk upon a determination that the at least one calculated probability of occurrence exceeds a given threshold.

4. The computer-implemented method of claim 1, wherein training the one or more machine learning techniques comprises using a Poisson distribution to model a cumulative variance for each of the one or more parameters related to the at least one supply chain.

5. The computer-implemented method of claim 1, wherein the one or more graph algorithms comprise one or more of at least one PageRank algorithm, at least one connected-component labeling algorithm, at least one triangle counting algorithm, at least one GraphX algorithm, at least one Louvain modularity algorithm, and at least one degree centrality algorithm.

6. The computer-implemented method of claim 1, wherein the one or more graph algorithms comprise a combination of two or more of at least one PageRank algorithm, at least one connected-component labeling algorithm, at least one triangle counting algorithm, at least one GraphX algorithm, at least one Louvain modularity algorithm, and at least one degree centrality algorithm.

7. The computer-implemented method of claim 1, wherein generating the at least one graph comprises generating a visualization of at least a portion of entities within a supply chain and information pertaining to one or more links between said entities.

8. The computer-implemented method of claim 1, wherein performing the at least one automated action comprises outputting information pertaining to the at least one identified issue to one or more security systems associated with the at least one supply chain.

9. The computer-implemented method of claim 1, wherein the data pertaining to the one or more inventory items comprise information pertaining to at least one of inventory item category, inventory item quantity, inventory item user, one or more inventory item timestamps, inventory item location, inventory item supplier, inventory item vendor, mode of payment, one or more payment terms, and inventory item pricing.

10. The computer-implemented method of claim 1, wherein the data pertaining to the one or more inventory items comprise one or more inventory metrics comprising at least one of time spent in inventory, gross margin as a percentage of sales, inventory as a percentage of total assets, returns as a percentage of sales, and shipping costs as a percentage of sales.

11. The computer-implemented method of claim 1, wherein the audit data comprise, for a given temporal period, transaction data associated with the at least one supply chain.

12. A non-transitory processor-readable storage medium having stored therein program code of one or more software programs, wherein the program code when executed by at least one processing device causes the at least one processing device:
to obtain data pertaining to one or more inventory items in connection with at least one supply chain;
to train one or more machine learning techniques using at least a portion of the obtained data, wherein training the one or more machine learning techniques comprises determining one or more upper bounds and one or more lower bounds for one or more parameters related to the at least one supply chain;
to detect one or more anomalies in audit data pertaining to at least one inventory item within the at least one supply chain by processing at least a portion of the audit data using the one or more machine learning techniques;
to generate at least one graph representing one or more portions of the at least one supply chain based at least in part on one or more portions of the obtained data and one or more portions of the audit data;
to identify at least one issue within at least one portion of the at least one supply chain by processing the at least one graph in connection with the one or more detected anomalies using one or more graph algorithms; and
to perform at least one automated action based at least in part on the at least one identified issue.

13. The non-transitory processor-readable storage medium of claim 12, wherein performing the at least one automated action comprises calculating at least one probability of occurrence for the at least one identified issue using one or more Bayesian inference techniques.

14. The non-transitory processor-readable storage medium of claim 13, wherein performing the at least one automated action comprises labeling the at least one identified issue as a security risk upon a determination that the at least one calculated probability of occurrence exceeds a given threshold.

15. The non-transitory processor-readable storage medium of claim 12, wherein training the one or more machine learning techniques comprises using a Poisson distribution to model a cumulative variance for each of the one or more parameters related to the at least one supply chain.

16. The non-transitory processor-readable storage medium of claim 12, wherein the one or more graph algorithms comprise one or more of at least one PageRank algorithm, at least one connected-component labeling algorithm, at least one triangle counting algorithm, at least one GraphX algorithm, at least one Louvain modularity algorithm, and at least one degree centrality algorithm.

17. An apparatus comprising:
at least one processing device comprising a processor coupled to a memory;
the at least one processing device being configured:
to obtain data pertaining to one or more inventory items in connection with at least one supply chain;
to train one or more machine learning techniques using at least a portion of the obtained data, wherein training the one or more machine learning techniques comprises determining one or more upper bounds and one or more lower bounds for one or more parameters related to the at least one supply chain;
to detect one or more anomalies in audit data pertaining to at least one inventory item within the at least one supply chain by processing at least a portion of the audit data using the one or more machine learning techniques;
to generate at least one graph representing one or more portions of the at least one supply chain based at least in part on one or more portions of the obtained data and one or more portions of the audit data;
to identify at least one issue within at least one portion of the at least one supply chain by processing the at least one graph in connection with the one or more detected anomalies using one or more graph algorithms; and
to perform at least one automated action based at least in part on the at least one identified issue.

18. The apparatus of claim 17, wherein performing the at least one automated action comprises calculating at least one probability of occurrence for the at least one identified issue using one or more Bayesian inference techniques.

19. The apparatus of claim 18, wherein performing the at least one automated action comprises labeling the at least one identified issue as a security risk upon a determination that the at least one calculated probability of occurrence exceeds a given threshold.

20. The apparatus of claim 17, wherein training the one or more machine learning techniques comprises using a Poisson distribution to model a cumulative variance for each of the one or more parameters related to the at least one supply chain.
